(19) United States
(12) Patent Application Publication
(10) Pub. No.: US 2020/0191431 A1
(43) Pub. Date: Jun. 18, 2020

(54) ACTUATOR HOUSING WITH QUICK ASSEMBLY DESIGN

(71) Applicant: Johnson Controls Technology Company, Auburn Hills, MI (US)

(72) Inventors: Parag Jivanrao Bhongade, Wardha (IN); Lakhan Shivaji Doke, Pune (IN); Marcello Passoni, Vimercate (IT); Duraigopal Vijayanandh, Tamilnadu (IN)

(73) Assignee: Johnson Controls Technology Company, Auburn Hills, MI (US)

(21) Appl. No.: 16/217,404

(22) Filed: Dec. 12, 2018

(51) Int. Cl. F24F 13/00; F16K 31/05

(52) U.S. Cl. CPC F24F 13/00; F16K 31/055

(57) ABSTRACT

A variety of assemblies are configured for use with an actuator. One embodiment relates to an actuator that includes a cover and a lower body. The cover includes a first cover end, a second cover end disposed axially away from the first cover end, the second cover end in contact with a lower body, a cover surface disposed between the first cover end and the second cover end, a protrusion radially disposed along an external surface of the cover surface, and a plurality of snap elements that extend axially away from the first cover end. The lower body includes a first body end, the first body end configured to receive the second cover end, a second body end disposed axially away from the first body end, a body surface extending axially between the first cover end and the second cover end; and a plurality of snapping surfaces.

### BACKGROUND

The present disclosure relates generally to actuators in a heating, ventilating, or air conditioning (HVAC) system, and more particularly, to assembly of an enclosure for an HVAC actuator.

HVAC actuators are used to operate a wide variety of HVAC components, such as air dampers, fluid valves, air handling units, and other components that are typically used in HVAC systems. For example, an actuator may be coupled to a damper in an HVAC system and may be used to drive the damper between an open position and a closed position. An HVAC actuator typically includes a cable which provides and/or receives electrical signals to or from the HVAC actuator. These signals may power or control the HVAC actuator. Electronic valve actuators typically include a body and a cover, where the cover is attached to the body using screws or other types of fasteners to seal the interior of the body.

### SUMMARY

One embodiment of the present disclosure relates to an actuator that includes a cover and a lower body. The cover includes a first cover end, a second cover end disposed axially away from the first cover end, the second cover end in contact with a lower body, a cover surface disposed between the first cover end and the second cover end, a protrusion radially disposed along an external surface of the cover surface, and a plurality of snap elements that extend axially away from the first cover end. The lower body includes a first body end, the first body end configured to receive the second cover end, a second body end disposed axially away from the first body end, a body surface extending axially between the first cover end and the second cover end; and a plurality of snapping surfaces disposed along an internal surface of the body surface, the plurality of snapping surfaces configured to engage the plurality of snap elements.

In some embodiments, a top cover includes a first top end, a second top end disposed axially away from the first top end, the second top end in contact with the first cover end; a top surface disposed between the first top end and the second top end; a groove radially disposed along an internal surface of the top surface, wherein the protrusion radially disposed along the external surface of the cover surface is configured to engage the groove radially disposed along the internal surface of the top surface.

In some embodiments, the first body end further comprises a body channel, the body channel configured to receive a seal member and sealingly engage with the second cover end.

In some embodiments, the first cover end further comprises a cover opening and a cover channel, the cover channel configured to receive a seal member and sealingly engage with the an internal surface of the first top end.

In some embodiments, each snap element in the plurality of snap elements comprises a first axial sidewall extending axially away from the first cover end toward the second cover end, the first axial sidewall configured to flex radially; a second axial sidewall extending axially away from the first cover end toward the second cover end, the second axial sidewall substantially parallel to the first axial sidewall, the second axial sidewall configured to flex radially; and an engagement surface disposed between the first axial sidewall and the second axial sidewall, the engagement surface configured to contact the plurality of snapping surfaces and cause the first axial sidewall and the second axial sidewall to flex radially.

In some embodiments, each snap surface in the plurality of snapping surfaces includes a slanted axially extending rectangular surface, the axially extending rectangular surface configured to engage the engagement surface on each snap element in the plurality of snap elements, wherein the engagement causes each snap element in the plurality of snap elements to flex radially inward.

In some embodiments, the plurality of snapping surfaces are adjacent to the first body end.

In some embodiments, the lower body further comprises a housing base adjacent the second body end, the housing base comprising a plurality of gear shaft locators, each gear shaft locator in the plurality of gear shaft locators configured to receive an axle of a gear in a gear train.

In some embodiments, the lower body further comprises a housing base adjacent the second body end, the housing base comprising a plurality of bracket locators, each bracket locator in the plurality of bracket locators configured to receive an engagement member of a bracket, the bracket configured to secure a gear train within the lower body.

In some embodiments, the lower body further comprises a housing base adjacent the second body end, the housing base comprising a plurality of assembly plate locators, each assembly plate locator in the plurality of assembly plate locators configured to receive an engagement member of an assembly plate.

In some embodiments, an assembly plate contained within the lower body, the assembly plate comprising a first protruding snap member, a second protruding snap member, and a motor.

In some embodiments, a circuit board, the circuit board comprising a first opening and a second opening, the first opening configured to receive the first protruding snap member, and the second opening configured to receive the second protruding snap member.

In some embodiments, a gear train contained within the lower body and coupled to a movable component for driving the movable component between multiple positions, the gear train comprising a plurality of shafts; and at least one compound gear freely and rotatably mounted on each shaft in the plurality of shafts, each compound gear comprising a main gear, a pinion gear, and a gear hub, the main gear co-axial with the pinion gear and the gear hub, the gear hub configured to reduce fouling of bosses to the at least one compound gear, each compound gear on each shaft intermeshed with a compound gear on another shaft in the plurality of shafts, the intermeshing configured to transfer torque, wherein at least one compound gear is operably connected to the motor.

In some embodiments, a method of assembling an actuator is described. The assembly includes placing a cover over a lower body, the cover, comprising a first cover end, a second cover end disposed axially away from the first cover end, the second cover end in contact with a lower body, a cover surface disposed between the first cover end and the second cover end, a protrusion radially disposed along an external surface of the cover surface; and a plurality of snap elements that extend axially away from the first cover end, the lower body, comprising a first body end, the first body end configured to receive the second cover end, a second body end disposed axially away from the first body end, a body surface extending axially between the first cover end and the second cover end, and a plurality of snapping surfaces disposed along an internal surface of the body surface; engaging the lower body with the cover, the engagement comprising the plurality of snap elements contacting the plurality of snapping surfaces and engaging to secure the cover onto the lower body.

In some embodiments, before engaging the lower body with the cover, a gear train is inserted within lower body, the gear train comprising a plurality of shafts and at least one compound gear freely and rotatably mounted on each shaft in the plurality of shafts, each compound gear comprising a main gear, a pinion gear, and a gear hub, the main gear co-axial with the pinion gear and the gear hub, the gear hub configured to reduce fouling of bosses to the at least one compound gear, each compound gear on each shaft intermeshed with a compound gear on another shaft in the plurality of shafts, the intermeshing configured to transfer torque, wherein each shaft is aligned with a complementary gear shaft locator dispose within the lower body.

In some embodiments, before engaging the lower body with the cover, a bracket is secured to the gear train, the bracket configured to secure the gear train to the lower body, the bracket comprising at least one screw configured to engage at least one nut member in the lower body.

In some embodiments, before engaging the lower body with the cover, an assembly plate is inserted within the lower body above the gear train, the assembly plate comprising a first protruding snap member, a second protruding snap member, and a motor, the motor configured to drive the gear train.

In some embodiments, before engaging the lower body with the cover a circuit board is inserted into the housing; the circuit board comprising a first opening and a second opening; securing the circuit board to the assembly plate, the first opening receiving the first protruding snap member and the second opening receiving the second protruding snap member.

In some embodiments, a top cover is secured to the cover, the top cover comprising a first top end, a second top end disposed axially away from the first top end, the second top end in contact with the first cover end, a top surface disposed between the first top end and the second top end, and a groove radially disposed along an internal surface of the top surface, wherein the protrusion radially disposed along the external surface of the cover surface engages the groove radially disposed along the internal surface of the top surface top secure the top cover to the cover.

In some embodiments, each snap element in the plurality of snap elements comprises a first axial sidewall extending axially away from the first cover end toward the second cover end, the first axial sidewall configured to flex radially; a second axial sidewall extending axially away from the first cover end toward the second cover end, the second axial sidewall substantially parallel to the first axial sidewall, the second axial sidewall configured to flex radially; and an engagement surface disposed between the first axial sidewall and the second axial sidewall, the engagement surface configured to contact the plurality of snapping surfaces and cause the first axial sidewall and the second axial sidewall to flex radially and wherein each snap surface in the plurality of snapping surfaces includes a slanted axially extending rectangular surface, the axially extending rectangular surface configured to engage the engagement surface on each snap element in the plurality of snap elements, wherein the engagement causes each snap element in the plurality of snap elements to flex radially inward.

### BRIEF DESCRIPTION OF THE DRAWINGS

FIG. 1 is a drawing of a building equipped with a heating, ventilating, or air conditioning (HVAC) system and a building management system (BMS), according to an exemplary embodiment.

FIG. 2 is a schematic diagram of a waterside system which may be used to support the HVAC system of FIG. 1, according to an exemplary embodiment.

FIG. 3 is a block diagram of an airside system which may be used as part of the HVAC system of FIG. 1, according to an exemplary embodiment.

FIG. 4 is a block diagram of a BMS which may be implemented in the building of FIG. 1, according to an exemplary embodiment.

FIG. 5 is an exploded view of an actuator which may be used in the HVAC system of FIG. 1, the waterside system of FIG. 2, the airside system of FIG. 3, or the BMS of FIG. 4 to control a HVAC component, according to an exemplary embodiment.

FIG. 6A is a perspective view of the middle cover of FIG. 5, according to an exemplary embodiment.

FIG. 6B is a top view of the middle cover of FIG. 6A.

FIG. 6C is a bottom perspective view of the middle cover of FIG. 6A.

FIG. 7 is a cross-sectional side view of the actuator of FIG. 5 assembled, according to an exemplary embodiment.

FIGS. 8A-8D are cross-sectional side views of portions of the actuator of FIG. 7.

FIG. 9 is an exploded view of an actuator which may be used in the HVAC system of FIG. 1, the waterside system of FIG. 2, the airside system of FIG. 3, or the BMS of FIG. 4 to control a HVAC component, according to an exemplary embodiment.

FIG. 10 is a perspective view of the actuator housing of FIG. 9, according to an exemplary embodiment.

FIGS. 11A-11C are views of an assembly plate of FIG. 9, according to an exemplary embodiment.

FIG. 12A is an exploded view of a control board and the assembly plate of FIGS. 11A-11B.

FIG. 12B is an assembled view of the control board and the assembly plate of FIG. 12A.

### DETAILED DESCRIPTION

Referring generally to the FIGURES, an actuator is shown, according to an exemplary embodiment. The actuator may be an HVAC actuator, such as a damper actuator, a valve actuator, a fan actuator, a pump actuator, or any other type of actuator that can be used in an HVAC system.

The actuator includes a housing. The housing includes a top cover, a middle cover, and a lower body. The top cover includes a first top surface and a second top surface. The second top surface is in contact with the middle cover and includes a groove annularly disposed therealong. The middle cover includes a first middle surface in contact with the second top surface and a second middle surface in contact with the lower body. The middle cover includes a protrusion annularly disposed along the first middle surface configured to engage the groove along the second top surface. A plurality of snap elements on the second middle surface extend axially away from the second middle surface. The lower body includes an internal wall and a lower body end. The internal wall extends axially from and away from the lower body end. A plurality of snapping surfaces is disposed along the internal wall. The plurality of snapping surfaces is configured to engage the plurality of snap elements.

Unlike conventional techniques, the aspects described herein may decrease the time of assembly through use of the body and a cover assembly that is snap-fit (e.g., press-fit) to the body without the need for screws or other fasteners. In addition to the snap-fit connections, the cover assembly includes at least one O-ring that engages the actuator body to provide IP54 ingress protection (e.g., water spray protection). In this manner, the present disclosure is easier to assemble and requires fewer components, as compared to conventional valve actuator assemblies. Various other benefits of the present disclosure will become apparent as follows.

### Building Management System and HVAC System

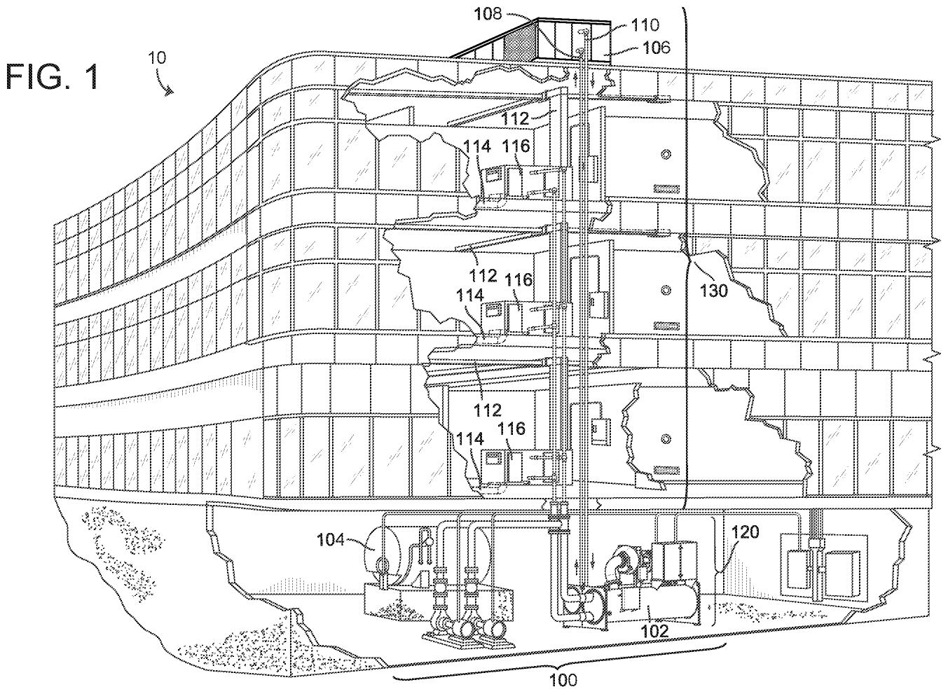

Referring now to FIGS. 1-4, an exemplary building management system (BMS) and HVAC system in which the systems and methods of the present invention may be implemented are shown, according to an exemplary embodiment. Referring particularly to FIG. 1, a perspective view of a building 10 is shown. Building 10 is served by a BMS. A BMS is, in general, a system of devices configured to control, monitor, and manage equipment in or around a building or building area. A BMS may include, for example, an HVAC system, a security system, a lighting system, a fire alerting system, and any other system that is capable of managing building functions or devices, or any combination thereof.

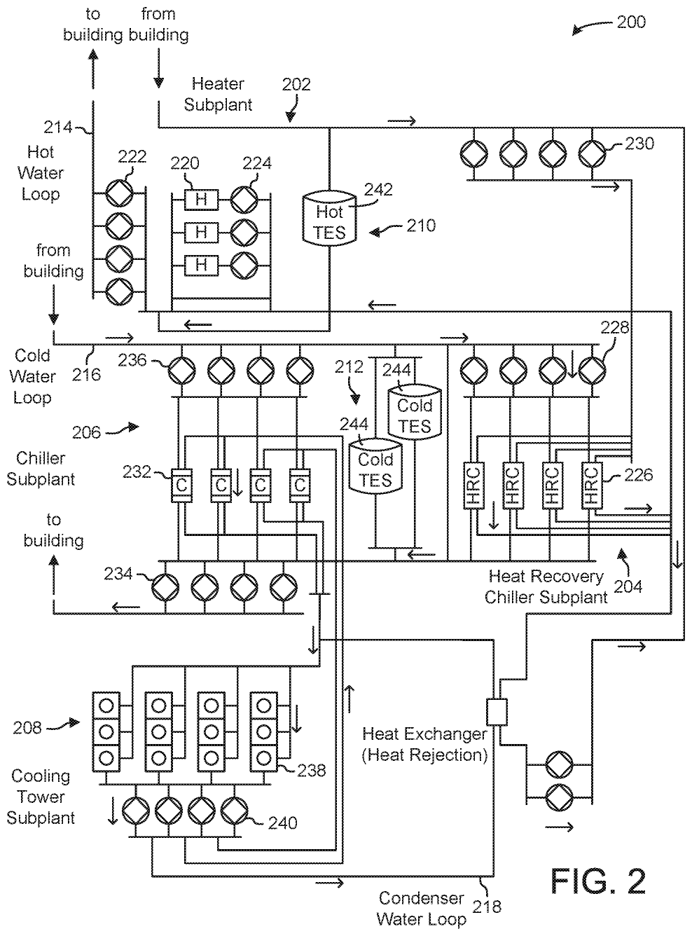

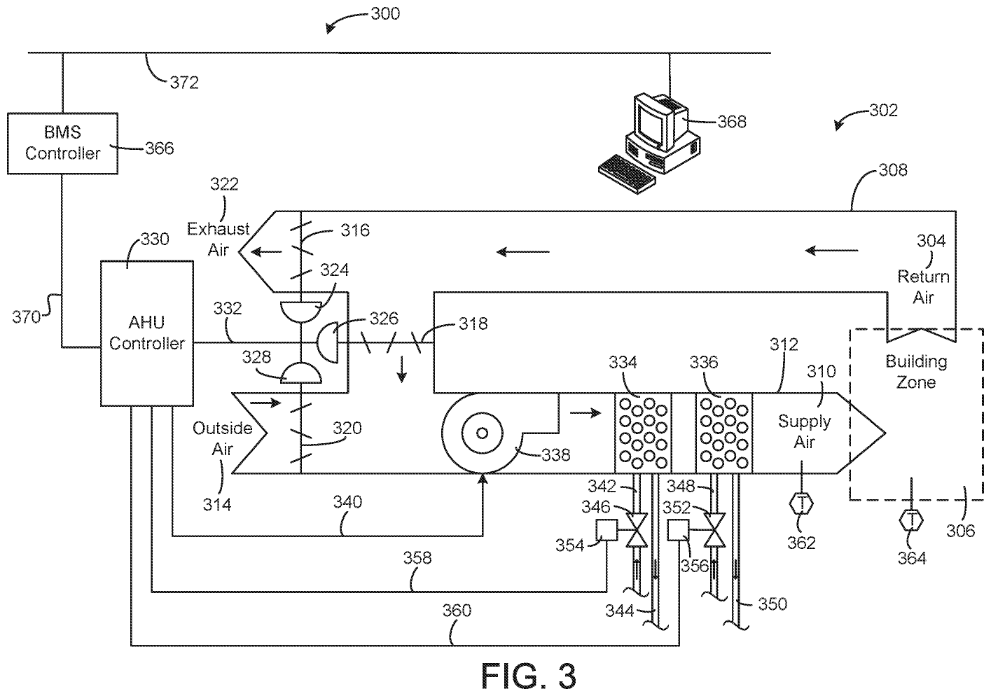

The BMS that serves building 10 includes an HVAC system 100. HVAC system 100 may include a plurality of HVAC devices (e.g., heaters, chillers, air handling units, pumps, fans, thermal energy storage, etc.) configured to provide heating, cooling, ventilation, or other services for building 10. For example, HVAC system 100 is shown to include a waterside system 120 and an airside system 130. Waterside system 120 may provide heated or chilled fluid to an air handling unit of airside system 130. Airside system 130 may use the heated or chilled fluid to heat or cool an airflow provided to building 10. An exemplary waterside system and airside system which may be used in HVAC system 100 are described in greater detail with reference to FIGS. 2-3.

HVAC system 100 is shown to include a chiller 102, a boiler 104, and a rooftop air handling unit (AHU) 106. Waterside system 120 may use boiler 104 and chiller 102 to heat or cool a working fluid (e.g., water, glycol, etc.) and may circulate the working fluid to AHU 106. In various embodiments, the HVAC devices of waterside system 120 may be located in or around building 10 (as shown in FIG. 1) or at an offsite location such as a central plant (e.g., a chiller plant, a steam plant, a heat plant, etc.). The working fluid may be heated in boiler 104 or cooled in chiller 102, depending on whether heating or cooling is required in building 10. Boiler 104 may add heat to the circulated fluid, for example, by burning a combustible material (e.g., natural gas) or using an electric heating element. Chiller 102 may place the circulated fluid in a heat exchange relationship with another fluid (e.g., a refrigerant) in a heat exchanger (e.g., an evaporator) to absorb heat from the circulated fluid. The working fluid from chiller 102 and/or boiler 104 may be transported to AHU 106 via piping 108.

AHU 106 may place the working fluid in a heat exchange relationship with an airflow passing through AHU 106 (e.g., via one or more stages of cooling coils and/or heating coils). The airflow may be, for example, outside air, return air from within building 10, or a combination of both. AHU 106 may transfer heat between the airflow and the working fluid to provide heating or cooling for the airflow. For example, AHU 106 may include one or more fans or blowers configured to pass the airflow over or through a heat exchanger containing the working fluid. The working fluid may then return to chiller 102 or boiler 104 via piping 110.

Airside system 130 may deliver the airflow supplied by AHU 106 (e.g., the supply airflow) to building 10 via air supply ducts 112 and may provide return air from building 10 to AHU 106 via air return ducts 114. In some embodiments, airside system 130 includes multiple variable air volume (VAV) units 116. For example, airside system 130 is shown to include a separate VAV unit 116 on each floor or zone of building 10. VAV units 116 may include dampers or other flow control elements that may be operated to control an amount of the supply airflow provided to individual zones of building 10. In other embodiments, airside system 130 delivers the supply airflow into one or more zones of building 10 (e.g., via supply ducts 112) without using intermediate VAV units 116 or other flow control elements. AHU 106 may include various sensors (e.g., temperature sensors, pressure sensors, etc.) configured to measure attributes of the supply airflow. AHU 106 may receive input from sensors located within AHU 106 and/or within the building zone and may adjust the flow rate, temperature, or other attributes of the supply airflow through AHU 106 to achieve set point conditions for the building zone.

Referring now to FIG. 2, a block diagram of a waterside system 200 is shown, according to an exemplary embodiment. In various embodiments, waterside system 200 may supplement or replace waterside system 120 in HVAC system 100 or may be implemented separate from HVAC system 100. When implemented in HVAC system 100, waterside system 200 may include a subset of the HVAC devices in HVAC system 100 (e.g., boiler 104, chiller 102, pumps, valves, etc.) and may operate to supply a heated or chilled fluid to AHU 106. The HVAC devices of waterside system 200 may be located within building 10 (e.g., as components of waterside system 120) or at an offsite location such as a central plant.

In FIG. 2, waterside system 200 is shown as a central plant having a plurality of subplants 202-212. Subplants 202-212 are shown to include a heater subplant 202, a heat recovery chiller subplant 204, a chiller subplant 206, a cooling tower subplant 208, a hot thermal energy storage (TES) subplant 210, and a cold thermal energy storage (TES) subplant 212. Subplants 202-212 consume resources (e.g., water, natural gas, electricity, etc.) from utilities to serve the thermal energy loads (e.g., hot water, cold water, heating, cooling, etc.) of a building or campus. For example, heater subplant 202 may be configured to heat water in a hot water loop 214 that circulates the hot water between heater subplant 202 and building 10. Chiller subplant 206 may be configured to chill water in a cold water loop 216 that circulates the cold water between chiller subplant 206 and building 10. Heat recovery chiller subplant 204 may be configured to transfer heat from cold water loop 216 to hot water loop 214 to provide additional heating for the hot water and additional cooling for the cold water. Condenser water loop 218 may absorb heat from the cold water in chiller subplant 206 and reject the absorbed heat in cooling tower subplant 208 or transfer the absorbed heat to hot water loop 214. Hot TES subplant 210 and cold TES subplant 212 may store hot and cold thermal energy, respectively, for subsequent use.

Hot water loop 214 and cold water loop 216 may deliver the heated and/or chilled water to air handlers located on the rooftop of building 10 (e.g., AHU 106) or to individual floors or zones of building 10 (e.g., VAV units 116). The air handlers push air past heat exchangers (e.g., heating coils or cooling coils) through which the water flows to provide heating or cooling for the air. The heated or cooled air may be delivered to individual zones of building 10 to serve the thermal energy loads of building 10. The water then returns to subplants 202-212 to receive further heating or cooling.

Although subplants 202-212 are shown and described as heating and cooling water for circulation to a building, it is understood that any other type of working fluid (e.g., glycol, CO2, etc.) may be used in place of or in addition to water to serve the thermal energy loads. In other embodiments, subplants 202-212 may provide heating and/or cooling directly to the building or campus without requiring an intermediate heat transfer fluid. These and other variations to waterside system 200 are within the teachings of the present invention.

Each of subplants 202-212 may include a variety of equipment configured to facilitate the functions of the subplant. For example, heater subplant 202 is shown to include a plurality of heating elements 220 (e.g., boilers, electric heaters, etc.) configured to add heat to the hot water in hot water loop 214. Heater subplant 202 is also shown to include several pumps 222 and 224 configured to circulate the hot water in hot water loop 214 and to control the flow rate of the hot water through individual heating elements 220. Chiller subplant 206 is shown to include a plurality of chillers 232 configured to remove heat from the cold water in cold water loop 216. Chiller subplant 206 is also shown to include several pumps 234 and 236 configured to circulate the cold water in cold water loop 216 and to control the flow rate of the cold water through individual chillers 232.

Heat recovery chiller subplant 204 is shown to include a plurality of heat recovery heat exchangers 226 (e.g., refrigeration circuits) configured to transfer heat from cold water loop 216 to hot water loop 214. Heat recovery chiller subplant 204 is also shown to include several pumps 228 and 230 configured to circulate the hot water and/or cold water through heat recovery heat exchangers 226 and to control the flow rate of the water through individual heat recovery heat exchangers 226. Cooling tower subplant 208 is shown to include a plurality of cooling towers 238 configured to remove heat from the condenser water in condenser water loop 218. Cooling tower subplant 208 is also shown to include several pumps 240 configured to circulate the condenser water in condenser water loop 218 and to control the flow rate of the condenser water through individual cooling towers 238.

Hot TES subplant 210 is shown to include a hot TES tank 242 configured to store the hot water for later use. Hot TES subplant 210 may also include one or more pumps or valves configured to control the flow rate of the hot water into or out of hot TES tank 242. Cold TES subplant 212 is shown to include cold TES tanks 244 configured to store the cold water for later use. Cold TES subplant 212 may also include one or more pumps or valves configured to control the flow rate of the cold water into or out of cold TES tanks 244.

In some embodiments, one or more of the pumps in waterside system 200 (e.g., pumps 222, 224, 228, 230, 234, 236, and/or 240) or pipelines in waterside system 200 include an isolation valve associated therewith. Isolation valves may be integrated with the pumps or positioned upstream or downstream of the pumps to control the fluid flows in waterside system 200. In various embodiments, waterside system 200 may include more, fewer, or different types of devices and/or subplants based on the particular configuration of waterside system 200 and the types of loads served by waterside system 200.

Referring now to FIG. 3, a block diagram of an airside system 300 is shown, according to an exemplary embodiment. In various embodiments, airside system 300 may supplement or replace airside system 130 in HVAC system 100 or may be implemented separate from HVAC system 100. When implemented in HVAC system 100, airside system 300 may include a subset of the HVAC devices in HVAC system 100 (e.g., AHU 106, VAV units 116, ducts 112-114, fans, dampers, etc.) and may be located in or around building 10. Airside system 300 may operate to heat or cool an airflow provided to building 10 using a heated or chilled fluid provided by waterside system 200.

In FIG. 3, airside system 300 is shown to include an economizer-type AHU 302. Economizer-type AHUs vary the amount of outside air and return air used by the air handling unit for heating or cooling. For example, AHU 302 may receive return air 304 from building zone 306 via return air duct 308 and may deliver supply air 310 to building zone 306 via supply air duct 312. In some embodiments, AHU 302 is a rooftop unit located on the roof of building 10 (e.g., AHU 106 as shown in FIG. 1) or otherwise positioned to receive both return air 304 and outside air 314. AHU 302 may be configured to operate exhaust air damper 316, mixing damper 318, and outside air damper 320 to control an amount of outside air 314 and return air 304 that combine to form supply air 310. Any return air 304 that does not pass through mixing damper 318 may be exhausted from AHU 302 through exhaust damper 316 as exhaust air 322.

Each of dampers 316-320 may be operated by an actuator. For example, exhaust air damper 316 may be operated by actuator 324, mixing damper 318 may be operated by actuator 326, and outside air damper 320 may be operated by actuator 328. Actuators 324-328 may communicate with an AHU controller 330 via a communications link 332. Actuators 324-328 may receive control signals from AHU controller 330 and may provide feedback signals to AHU controller 330. Feedback signals may include, for example, an indication of a current actuator or damper position, an amount of torque or force exerted by the actuator, diagnostic information (e.g., results of diagnostic tests performed by actuators 324-328), status information, commissioning information, configuration settings, calibration data, and/or other types of information or data that may be collected, stored, or used by actuators 324-328. AHU controller 330 may be an economizer controller configured to use one or more control algorithms (e.g., state-based algorithms, extremum seeking control (ESC) algorithms, proportional-integral (PI) control algorithms, proportional-integral-derivative (PID) control algorithms, model predictive control (MPC) algorithms, feedback control algorithms, etc.) to control actuators 324-328.

Still referring to FIG. 3, AHU 302 is shown to include a cooling coil 334, a heating coil 336, and a fan 338 positioned within supply air duct 312. Fan 338 may be configured to force supply air 310 through cooling coil 334 and/or heating coil 336 and provide supply air 310 to building zone 306. AHU controller 330 may communicate with fan 338 via communications link 340 to control a flow rate of supply air 310. In some embodiments, AHU controller 330 controls an amount of heating or cooling applied to supply air 310 by modulating a speed of fan 338.

Cooling coil 334 may receive a chilled fluid from waterside system 200 (e.g., from cold water loop 216) via piping 342 and may return the chilled fluid to waterside system 200 via piping 344. Valve 346 may be positioned along piping 342 or piping 344 to control a flow rate of the chilled fluid through cooling coil 334. In some embodiments, cooling coil 334 includes multiple stages of cooling coils that may be independently activated and deactivated (e.g., by AHU controller 330, by BMS controller 366, etc.) to modulate an amount of cooling applied to supply air 310.

Heating coil 336 may receive a heated fluid from waterside system 200 (e.g., from hot water loop 214) via piping 348 and may return the heated fluid to waterside system 200 via piping 350. Valve 352 may be positioned along piping 348 or piping 350 to control a flow rate of the heated fluid through heating coil 336. In some embodiments, heating coil 336 includes multiple stages of heating coils that may be independently activated and deactivated (e.g., by AHU controller 330, by BMS controller 366, etc.) to modulate an amount of heating applied to supply air 310.

Each of valves 346 and 352 may be controlled by an actuator. For example, valve 346 may be controlled by actuator 354 and valve 352 may be controlled by actuator 356. Actuators 354-356 may communicate with AHU controller 330 via communications links 358-360. Actuators 354-356 may receive control signals from AHU controller 330 and may provide feedback signals to controller 330. In some embodiments, AHU controller 330 receives a measurement of the supply air temperature from a temperature sensor 362 positioned in supply air duct 312 (e.g., downstream of cooling coil 334 and/or heating coil 336). AHU controller 330 may also receive a measurement of the temperature of building zone 306 from a temperature sensor 364 located in building zone 306.

In some embodiments, AHU controller 330 operates valves 346 and 352 via actuators 354-356 to modulate an amount of heating or cooling provided to supply air 310 (e.g., to achieve a setpoint temperature for supply air 310 or to maintain the temperature of supply air 310 within a setpoint temperature range). The positions of valves 346 and 352 affect the amount of heating or cooling provided to supply air 310 by cooling coil 334 or heating coil 336 and may correlate with the amount of energy consumed to achieve a desired supply air temperature. AHU controller 330 may control the temperature of supply air 310 and/or building zone 306 by activating or deactivating coils 334-336, adjusting a speed of fan 338, or a combination of both.

Still referring to FIG. 3, airside system 300 is shown to include a BMS controller 366 and a client device 368. BMS controller 366 may include one or more computer systems (e.g., servers, supervisory controllers, subsystem controllers, etc.) that serve as system-level controllers, application or data servers, head nodes, or master controllers for airside system 300, waterside system 200, HVAC system 100, and/or other controllable systems that serve building 10. BMS controller 366 may communicate with multiple downstream building systems or subsystems (e.g., HVAC system 100, a security system, a lighting system, waterside system 200, etc.) via a communications link 370 according to like or disparate protocols (e.g., LON, BACnet, etc.). In various embodiments, AHU controller 330 and BMS controller 366 may be separate (as shown in FIG. 3) or integrated. In an integrated implementation, AHU controller 330 may be a software module configured for execution by a processor of BMS controller 366.

In some embodiments, AHU controller 330 receives information from BMS controller 366 (e.g., commands, setpoints, operating boundaries, etc.) and provides information to BMS controller 366 (e.g., temperature measurements, valve or actuator positions, operating statuses, diagnostics, etc.). For example, AHU controller 330 may provide BMS controller 366 with temperature measurements from temperature sensors 362-364, equipment on/off states, equipment operating capacities, and/or any other information that may be used by BMS controller 366 to monitor or control a variable state or condition within building zone 306.

Client device 368 may include one or more human-machine interfaces or client interfaces (e.g., graphical user interfaces, reporting interfaces, text-based computer interfaces, client-facing web services, web servers that provide pages to web clients, etc.) for controlling, viewing, or otherwise interacting with HVAC system 100, its subsystems, and/or devices. Client device 368 may be a computer workstation, a client terminal, a remote or local interface, or any other type of user interface device. Client device 368 may be a stationary terminal or a mobile device. For example, client device 368 may be a desktop computer, a computer server with a user interface, a laptop computer, a tablet, a smartphone, a PDA, or any other type of mobile or non-mobile device. Client device 368 may communicate with BMS controller 366 and/or AHU controller 330 via communications link 372.

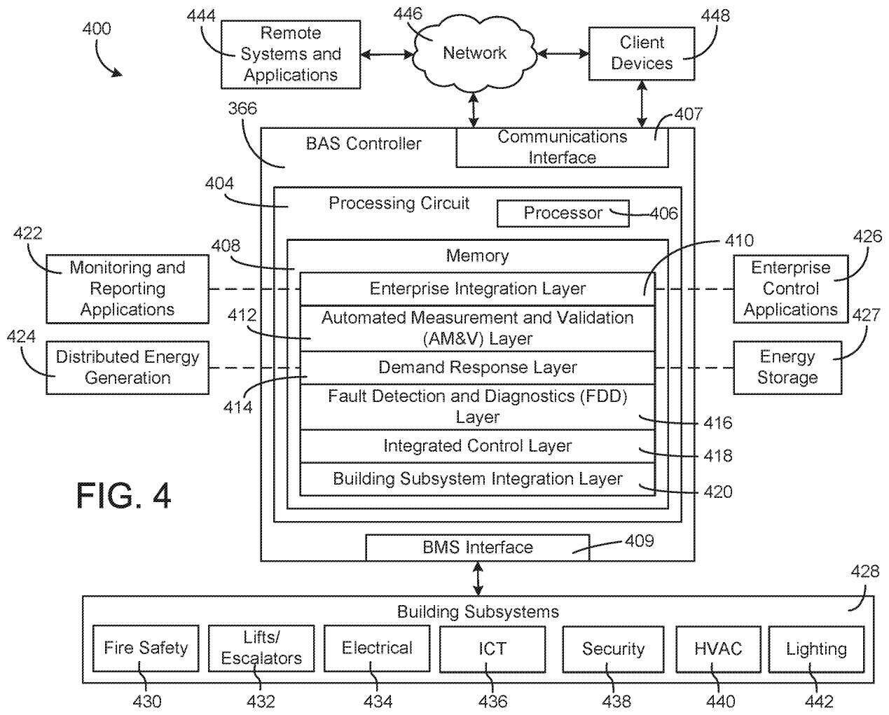

Referring now to FIG. 4, a block diagram of a BMS 400 is shown, according to an exemplary embodiment. BMS 400 may be implemented in building 10 to automatically monitor and control various building functions. BMS 400 is shown to include BMS controller 366 and a plurality of building subsystems 428. Building subsystems 428 are shown to include a building electrical subsystem 434, an information communication technology (ICT) subsystem 436, a security subsystem 438, an HVAC subsystem 440, a lighting subsystem 442, a lift/escalators subsystem 432, and a fire safety subsystem 430. In various embodiments, building subsystems 428 may include fewer, additional, or alternative subsystems. For example, building subsystems 428 may also or alternatively include a refrigeration subsystem, an advertising or signage subsystem, a cooking subsystem, a vending subsystem, a printer or copy service subsystem, or any other type of building subsystem that uses controllable equipment and/or sensors to monitor or control building 10. In some embodiments, building subsystems 428 include waterside system 200 and/or airside system 300, as described with reference to FIGS. 2-3.

Each of building subsystems 428 may include any number of devices, controllers, and connections for completing its individual functions and control activities. HVAC subsystem 440 may include many of the same components as HVAC system 100, as described with reference to FIGS. 1-3. For example, HVAC subsystem 440 may include any number of chillers, heaters, handling units, economizers, field controllers, supervisory controllers, actuators, temperature sensors, and/or other devices for controlling the temperature, humidity, airflow, or other variable conditions within building 10. Lighting subsystem 442 may include any number of light fixtures, ballasts, lighting sensors, dimmers, or other devices configured to controllably adjust the amount of light provided to a building space. Security subsystem 438 may include occupancy sensors, video surveillance cameras, digital video recorders, video processing servers, intrusion detection devices, access control devices and servers, or other security-related devices.

Still referring to FIG. 4, BMS controller 366 is shown to include a communications interface 407 and a BMS interface 409. Interface 407 may facilitate communications between BMS controller 366 and external applications (e.g., monitoring and reporting applications 422, enterprise control applications 426, remote systems and applications 444, applications residing on client devices 448, etc.) for allowing user control, monitoring, and adjustment to BMS controller 366 and/or subsystems 428. Interface 407 may also facilitate communications between BMS controller 366 and client devices 448. BMS interface 409 may facilitate communications between BMS controller 366 and building subsystems 428 (e.g., HVAC, lighting security, lifts, power distribution, business, etc.).

Interfaces 407 and 409 may be or may include wired or wireless communications interfaces (e.g., jacks, antennas, transmitters, receivers, transceivers, wire terminals, etc.) for conducting data communications with building subsystems 428 or other external systems or devices. In various embodiments, communications via interfaces 407 and 409 may be direct (e.g., local wired or wireless communications) or via a communications network 446 (e.g., a WAN, the Internet, a cellular network, etc.). For example, interfaces 407 and 409 may include an Ethernet card and port for sending and receiving data via an Ethernet-based communications link or network. In another example, interfaces 407 and 409 may include a Wi-Fi transceiver for communicating via a wireless communications network. In another example, one or both of interfaces 407 and 409 may include cellular or mobile phone communications transceivers. In one embodiment, communications interface 407 is a power line communications interface and BMS interface 409 is an Ethernet interface. In other embodiments, both communications interface 407 and BMS interface 409 are Ethernet interfaces or are the same Ethernet interface.

Still referring to FIG. 4, BMS controller 366 is shown to include a processing circuit 404 including a processor 406 and memory 408. Processing circuit 404 may be communicably connected to BMS interface 409 and/or communications interface 407 such that processing circuit 404 and the various components thereof may send and receive data via interfaces 407 and 409. Processor 406 may be implemented as a general purpose processor, an application specific integrated circuit (ASIC), one or more field programmable gate arrays (FPGAs), a group of processing components, or other suitable electronic processing components.

Memory 408 (e.g., memory, memory unit, storage device, etc.) may include one or more devices (e.g., RAM, ROM, Flash memory, hard disk storage, etc.) for storing data and/or computer code for completing or facilitating the various processes, layers, and modules described in the present application. Memory 408 may be or include volatile memory or non-volatile memory. Memory 408 may include database components, object code components, script components, or any other type of information structure for supporting the various activities and information structures described in the present application. According to an exemplary embodiment, memory 408 is communicably connected to processor 406 via processing circuit 404 and includes computer code for executing (e.g., by processing circuit 404 and/or processor 406) one or more processes described herein.

In some embodiments, BMS controller 366 is implemented within a single computer (e.g., one server, one housing, etc.). In various other embodiments, BMS controller 366 may be distributed across multiple servers or computers (e.g., that may exist in distributed locations). Further, while FIG. 4 shows applications 422 and 426 as existing outside of BMS controller 366, in some embodiments, applications 422 and 426 may be hosted within BMS controller 366 (e.g., within memory 408).

Still referring to FIG. 4, memory 408 is shown to include an enterprise integration layer 410, an automated measurement and validation (AM&V) layer 412, a demand response (DR) layer 414, a fault detection and diagnostics (FDD) layer 416, an integrated control layer 418, and a building subsystem integration later 420. Layers 410-420 may be configured to receive inputs from building subsystems 428 and other data sources, determine optimal control actions for building subsystems 428 based on the inputs, generate control signals based on the optimal control actions, and provide the generated control signals to building subsystems 428. The following paragraphs describe some of the general functions performed by each of layers 410-420 in BMS 400.

Enterprise integration layer 410 may be configured to serve clients or local applications with information and services to support a variety of enterprise-level applications. For example, enterprise control applications 426 may be configured to provide subsystem-spanning control to a graphical user interface (GUI) or to any number of enterprise-level business applications (e.g., accounting systems, user identification systems, etc.). Enterprise control applications 426 may also or alternatively be configured to provide configuration GUIs for configuring BMS controller 366. In yet other embodiments, enterprise control applications 426 may work with layers 410-420 to optimize building performance (e.g., efficiency, energy use, comfort, or safety) based on inputs received at interface 407 and/or BMS interface 409.

Building subsystem integration layer 420 may be configured to manage communications between BMS controller 366 and building subsystems 428. For example, building subsystem integration layer 420 may receive sensor data and input signals from building subsystems 428 and provide output data and control signals to building subsystems 428. Building subsystem integration layer 420 may also be configured to manage communications between building subsystems 428. Building subsystem integration layer 420 translates communications (e.g., sensor data, input signals, output signals, etc.) across a plurality of multi-vendor/multi-protocol systems.

Demand response layer 414 may be configured to optimize resource usage (e.g., electricity use, natural gas use, water use, etc.) and/or the monetary cost of such resource usage in response to satisfy the demand of building 10. The optimization may be based on time-of-use prices, curtailment signals, energy availability, or other data received from utility providers, distributed energy generation systems 424, from energy storage 427 (e.g., hot TES 242, cold TES 244, etc.), or from other sources. Demand response layer 414 may receive inputs from other layers of BMS controller 366 (e.g., building subsystem integration layer 420, integrated control layer 418, etc.). The inputs received from other layers may include environmental or sensor inputs such as temperature, carbon dioxide levels, relative humidity levels, air quality sensor outputs, occupancy sensor outputs, room schedules, and the like. The inputs may also include inputs such as electrical use (e.g., expressed in kWh), thermal load measurements, pricing information, projected pricing, smoothed pricing, curtailment signals from utilities, and the like.

According to an exemplary embodiment, demand response layer 414 includes control logic for responding to the data and signals it receives. These responses may include communicating with the control algorithms in integrated control layer 418, changing control strategies, changing setpoints, or activating/deactivating building equipment or subsystems in a controlled manner. Demand response layer 414 may also include control logic configured to determine when to utilize stored energy. For example, demand response layer 414 may determine to begin using energy from energy storage 427 just prior to the beginning of a peak use hour.

In some embodiments, demand response layer 414 includes a control module configured to actively initiate control actions (e.g., automatically changing setpoints) which minimize energy costs based on one or more inputs representative of or based on demand (e.g., price, a curtailment signal, a demand level, etc.). In some embodiments, demand response layer 414 uses equipment models to determine an optimal set of control actions. The equipment models may include, for example, thermodynamic models describing the inputs, outputs, and/or functions performed by various sets of building equipment. Equipment models may represent collections of building equipment (e.g., subplants, chiller arrays, etc.) or individual devices (e.g., individual chillers, heaters, pumps, etc.).

Demand response layer 414 may further include or draw upon one or more demand response policy definitions (e.g., databases, XML files, etc.). The policy definitions may be edited or adjusted by a user (e.g., via a graphical user interface) so that the control actions initiated in response to demand inputs may be tailored for the user's application, desired comfort level, particular building equipment, or based on other concerns. For example, the demand response policy definitions may specify which equipment may be turned on or off in response to particular demand inputs, how long a system or piece of equipment should be turned off, what setpoints may be changed, what the allowable set point adjustment range is, how long to hold a high demand setpoint before returning to a normally scheduled setpoint, how close to approach capacity limits, which equipment modes to utilize, the energy transfer rates (e.g., the maximum rate, an alarm rate, other rate boundary information, etc.) into and out of energy storage devices (e.g., thermal storage tanks, battery banks, etc.), and when to dispatch on-site generation of energy (e.g., via fuel cells, a motor generator set, etc.).

Integrated control layer 418 may be configured to use the data input or output of building subsystem integration layer 420 and/or demand response later 414 to make control decisions. Due to the subsystem integration provided by building subsystem integration layer 420, integrated control layer 418 may integrate control activities of the subsystems 428 such that the subsystems 428 behave as a single integrated supersystem. In an exemplary embodiment, integrated control layer 418 includes control logic that uses inputs and outputs from a plurality of building subsystems to provide greater comfort and energy savings relative to the comfort and energy savings that separate subsystems could provide alone. For example, integrated control layer 418 may be configured to use an input from a first subsystem to make an energy-saving control decision for a second subsystem. Results of these decisions may be communicated back to building subsystem integration layer 420.

Integrated control layer 418 is shown to be logically below demand response layer 414. Integrated control layer 418 may be configured to enhance the effectiveness of demand response layer 414 by enabling building subsystems 428 and their respective control loops to be controlled in coordination with demand response layer 414. This configuration may advantageously reduce disruptive demand response behavior relative to conventional systems. For example, integrated control layer 418 may be configured to assure that a demand response-driven upward adjustment to the setpoint for chilled water temperature (or another component that directly or indirectly affects temperature) does not result in an increase in fan energy (or other energy used to cool a space) that would result in greater total building energy use than was saved at the chiller.

Integrated control layer 418 may be configured to provide feedback to demand response layer 414 so that demand response layer 414 checks that constraints (e.g., temperature, lighting levels, etc.) are properly maintained even while demanded load shedding is in progress. The constraints may also include setpoint or sensed boundaries relating to safety, equipment operating limits and performance, comfort, fire codes, electrical codes, energy codes, and the like. Integrated control layer 418 is also logically below fault detection and diagnostics layer 416 and AM&V layer 412. Integrated control layer 418 may be configured to provide calculated inputs (e.g., aggregations) to these higher levels based on outputs from more than one building subsystem.

AM&V layer 412 may be configured to verify that control strategies commanded by integrated control layer 418 or demand response layer 414 are working properly (e.g., using data aggregated by AM&V layer 412, integrated control layer 418, building subsystem integration layer 420, FDD layer 416, or otherwise). The calculations made by AM&V layer 412 may be based on building system energy models and/or equipment models for individual BMS devices or subsystems. For example, AM&V layer 412 may compare a model-predicted output with an actual output from building subsystems 428 to determine an accuracy of the model.

FDD layer 416 may be configured to provide on-going fault detection for building subsystems 428, building subsystem devices (e.g., building equipment), and control algorithms used by demand response layer 414 and integrated control layer 418. FDD layer 416 may receive data inputs from integrated control layer 418, directly from one or more building subsystems or devices, or from another data source. FDD layer 416 may automatically diagnose and respond to detected faults. The responses to detected or diagnosed faults may include providing an alert message to a user, a maintenance scheduling system, or a control algorithm configured to attempt to repair the fault or to work-around the fault.

FDD layer 416 may be configured to output a specific identification of the faulty component or cause of the fault (e.g., loose damper linkage) using detailed subsystem inputs available at building subsystem integration layer 420. In other exemplary embodiments, FDD layer 416 is configured to provide “fault” events to integrated control layer 418 which executes control strategies and policies in response to the received fault events. According to an exemplary embodiment, FDD layer 416 (or a policy executed by an integrated control engine or business rules engine) may shut-down systems or direct control activities around faulty devices or systems to reduce energy waste, extend equipment life, or assure proper control response.

FDD layer 416 may be configured to store or access a variety of different system data stores (or data points for live data). FDD layer 416 may use some content of the data stores to identify faults at the equipment level (e.g., specific chiller, specific AHU, specific terminal unit, etc.) and other content to identify faults at component or subsystem levels. For example, building subsystems 428 may generate temporal (e.g., time-series) data indicating the performance of BMS 400 and the various components thereof. The data generated by building subsystems 428 may include measured or calculated values that exhibit statistical characteristics and provide information about how the corresponding system or process (e.g., a temperature control process, a flow control process, etc.) is performing in terms of error from its setpoint. These processes may be examined by FDD layer 416 to expose when the system begins to degrade in performance and alert a user to repair the fault before it becomes more severe.

### HVAC Actuator

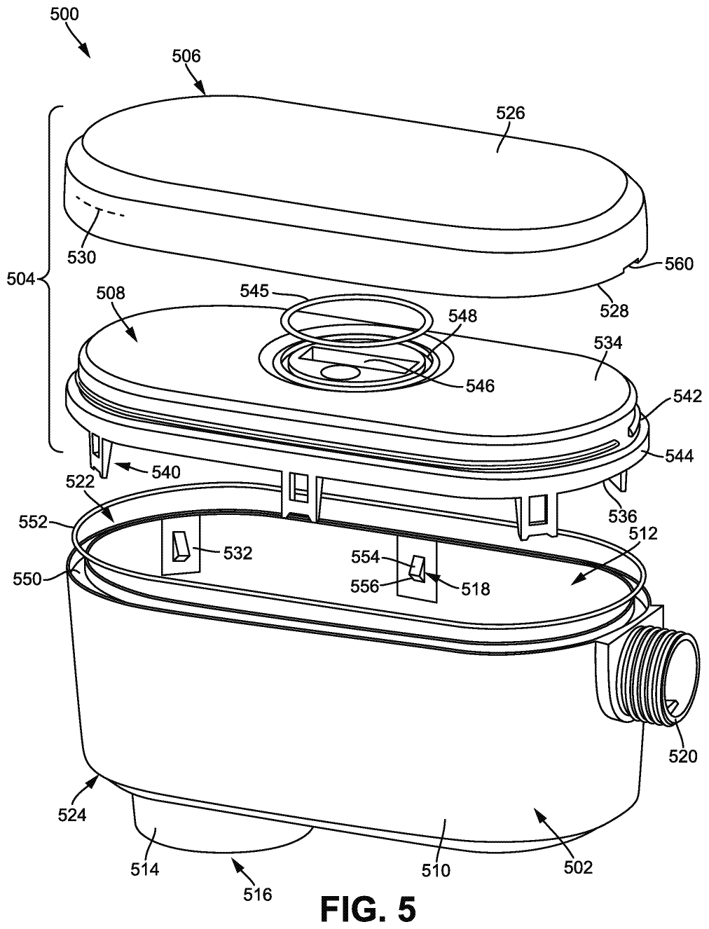

Referring now to FIG. 5, an actuator 500 is shown, according to an exemplary embodiment. In some implementations, the actuator 500 may be used in HVAC system 100, waterside system 200, airside system 300, or BMS system 400, as described with reference to FIGS. 1-4. For example, actuator 500 may be a damper actuator, a valve actuator, a fan actuator, a pump actuator, or any other type of actuator that may be used in an HVAC system or BMS. In various embodiments, actuator 500 may be a linear actuator (e.g., a linear proportional actuator), a non-linear actuator, a spring return actuator, or a non-spring return actuator.

Actuator 500 is shown to include a housing 502. The housing 502 may contain the mechanical and processing components of actuator 500 when assembled. In some embodiments, the housing 502 contains a brushless direct current (BLDC) motor and a processing circuit configured to provide a pulse width modulated (PWM) DC output to control the speed of the BLDC motor. In other embodiments, the housing 502 may contain other types of motors that are controllable (e.g., by the various processing components of the actuator 500 and/or the HVAC or BMS system 100, 400).

Actuator 500 may generally provide a mechanical output to various devices in the HVAC, waterside, airside, or BMS systems 100, 200, 300, 400. The actuator 500 may be a rotary actuator, a linear actuator, etc. Accordingly, the actuator 500 may provide different types of force outputs depending on configuration.

As shown in FIG. 5, the actuator 500 includes a cover assembly 504 and a housing 502. The cover assembly 504 is configured to snap-fit (e.g., press-fit) engage with the housing 502 and provide IP54 ingress protection (e.g., water spray protection) in all directions (e.g., 360-degrees) through the placement of the O-rings along various surfaces of the cover assembly 504 and housing 502. While the cover assembly 504 is described as engaging various features of the housing 502 in a snap-fit design, other engagement designs may be implemented (e.g., press fit). The cover assembly 504 includes a top cover 506 and a middle cover 508 that are engaged through a snap-fit or press-fit design.

The housing 502 includes a first housing end 522, a second housing end 524, an outer surface 510 disposed between the first housing end 522 and second housing end 524, and an interior housing surface 512 between the first housing end 522 and second housing end 524. The outer surface 510 and the interior housing surface 512 define the body (e.g., outside and inside, respectively) of the housing 502. The housing 502 includes a cylindrical channel wall 514 extending from the second housing end 524. An output channel 516 is formed within the channel wall 514, which is in communication with the interior housing surface 512. An O-ring groove 550 is disposed around a portion of the first housing end 522 and configured to receive an O-ring 552. As will be appreciated, the O-ring 552 is configured to provide IP54 ingress protection.

The channel wall 514 extends from the second housing end 524 and may be substantially cylindrical with openings at an exterior end and an interior end. The channel wall 514 defines an output channel 516 that allows access to the interior housing surface 512 from outside the actuator 500. The channel wall 514 has an interior surface that runs along the output channel 516. The channel wall 514 may have a uniform thickness or may taper towards the exterior end.

The interior housing surface 512 may receive or support any combination of control systems or circuit boards, electrical, hydraulic, pneumatic, or other power systems, gear trains or other mechanical components, or any other elements useful for the operation of actuator. In some embodiments, the interior volume contains a brushless direct current (BLDC) motor and a processing circuit configured to provide a pulse width modulated (PWM) DC output to control the speed of the BLDC motor. In other embodiments, the housing 502 may contain other types of motors that are controllable (e.g., by the various processing components of the actuator 500 and/or implemented systems).

The actuator 500 may receive power and/or control inputs from a remote source through the socket 520. In some embodiments, actuator 500 may include a cable for receiving power or control inputs. For example, the socket 520 is shown as threaded to engage a coupling device and cable. The actuator 500 may receive inputs and/or power from an overmolded cable. The overmolded cable may be attached to the housing 502 of the actuator 500 via a coupling device. For example, the coupling devices may be screwed into the socket 520 with a neck of the coupling devices pressed up against a stopper to secure the overmolded cable to the housing 502.

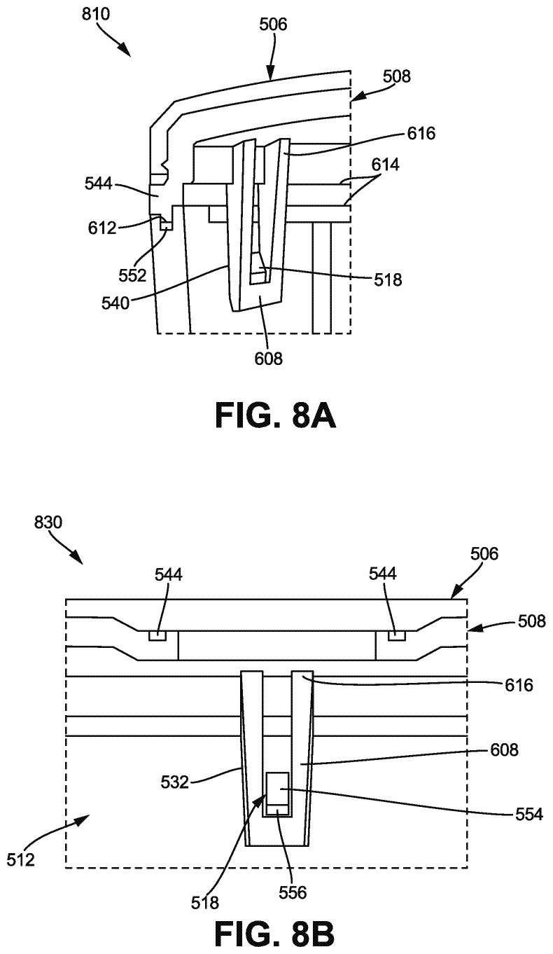

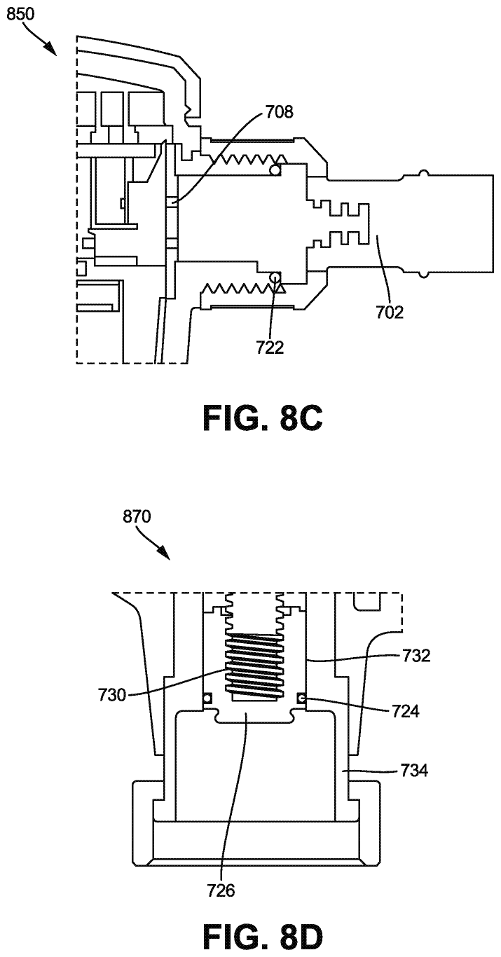

A plurality of snapping surfaces 518 are disposed along the interior housing surface 512. The plurality of snapping surfaces 518 are shown in FIG. 5 as having a trapezoidal shape with a slanted rectangular face on the top portion 554 and a rectangular prism bottom portion 556, formed as a single unit. A plurality of cantilever snap indentations 532 (e.g., receiving surface) may each be disposed around each snapping surface in the plurality of snapping surfaces 518. Each snap indentation in the plurality of cantilever snap indentations 532 is configured to receive a complementary snap in a plurality of snaps 540 on the middle cover 508 and facilitate the engagement of the middle cover 508 and the housing 502. The engagement of the plurality of snapping surfaces 518 and the plurality of snaps 540 is shown in FIGS. 7-8C. The engagement of the annular groove 530 and the annular snap structure 542 is shown in FIGS. 7-8C.

As shown in FIG. 5, the cover assembly 504 is a snap-fit body comprising two covers (e.g., the top cover 506 and the middle cover 508) that seal to protect the actuator 500 from humidity, water (e.g., liquid) splashing into the interior housing surface 512 (e.g., interior housing portion), and other liquid ingress that could disrupt operation of one or more components of the actuator 500. The cover assembly 504 may provide improved ingress protection relative to other actuators that provide IP40 ingress protection, by providing IP54 ingress protection in all directions. Additionally, the cover assembly 504 alleviates the need for one or more screws (or similar engagement materials) to attach the top and bottom housing portions and reduces the assembly time and the assembly lead time of the actuator 500.

The top cover 506 includes an outer top surface 526 and an internal top surface 528. The outer top surface 526 is the externally facing surface and is water tight to provide IP54 ingress protection. The outer top surface 526 may have an ergonomical shape. The internal top surface 528 is configured to engage the middle cover 508. The internal top surface 528 includes an annular groove 530 configured to snap-fit interface with a complementary annular snap structure 542 on the middle cover 508. Engagement of the annular groove 530 and the annular snap structure 542 is shown in FIGS. 7-8C. In some embodiments, one or more notches 560 are provided between the outer top surface 526 and an internal top surface 528 to facilitate removal or the top cover 506 and/or the cover assembly from the housing 502.

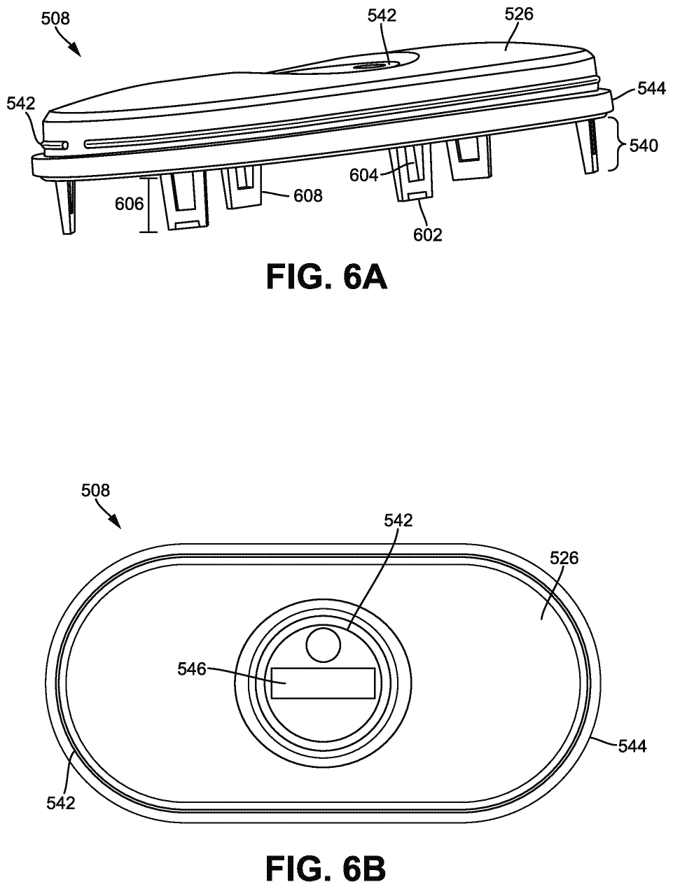

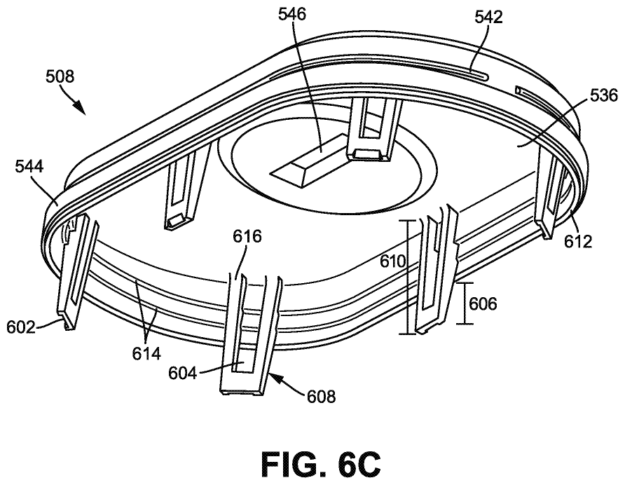

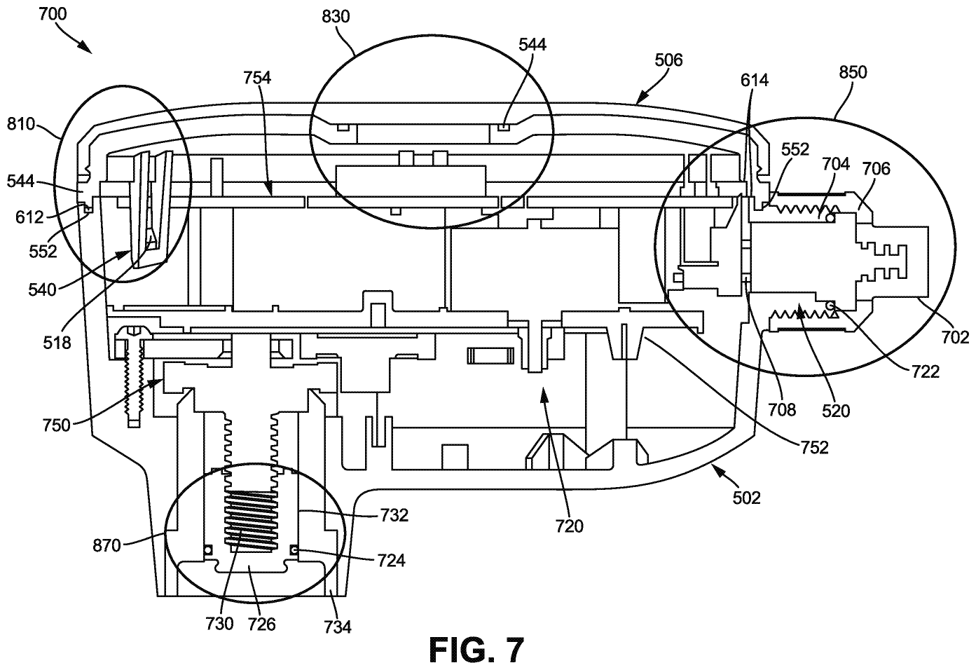

The middle cover 508 includes an outer middle surface 534 and an internal middle surface 536. The outer middle surface 534 includes an annular snap structure 542 and an O-ring groove 548. The annular snap structure 542 is disposed around a middle portion of the outer middle surface 534 and is configured to engage the annular groove 530 on the internal top surface 528 of the top cover 506 to secure the middle cover 508 and the top cover 506. As shown in FIG. 5, the O-ring groove 548 is centrally disposed on the outer middle surface 534 and is configured to receive an O-ring 545. The O-ring groove 548 and O-ring 545 are configured to provide IP54 ingress protection. A middle cover opening 546 is formed inside of the O-ring groove 548 and extends from the outer middle surface 534 through to the internal middle surface 536. As shown in FIGS. 5-6C, the middle cover opening 546 is a rectangular opening.

A rim 544 is disposed between the outer middle surface 534 and the internal middle surface 536. The rim 544 is configured to engage the first housing end 522 in a press-fit or snap-fit manner, as shown in FIGS. 7, 8A, and 8C. As shown in FIG. 6C, a bottom portion 612 of the rim 544 is configured to engage the O-ring groove 550 on the housing 502, such that the O-ring 552 is pressed between the O-ring groove 550 and the bottom portion 612 of the rim 544.

A plurality of snaps 540 protrude from the internal middle surface 536 toward the housing 502 and are configured to engage the plurality of snapping surfaces 518 to secure the middle cover 508 to the housing 502. Turning to FIGS. 6A-6C, the middle cover 508 is shown in various perspectives. Each snap in the plurality of snapping surfaces 518 is a “U”-shaped snap protrusion 608 with an opening 604 disposed within the center of the snap protrusion 608. Each snap protrusion 608 extends a length 606 from the rim 544. Each snap protrusion 608 is a flexible member with an engagement surface 602 disposed on a tip of the bottom end of the snap protrusion 608. Each engagement surface 602 is configured to come into contact with the top portion 554 of a snap surface in the plurality of snapping surfaces 518 such that the snap protrusion 608 flexes inward as it moves axially along the length of the snapping surface 518 until it axially passes over the rectangular prism bottom portion 556. Once the engagement surface 602 of the snap protrusion 608 passes over the rectangular prism bottom portion 556, the snap protrusion 608 flexes outward and the snap surface is disposed within the opening 604 of the snap protrusion 608 and the middle cover 508 is engaged with the housing 502. As is readily apparent, each snap in the plurality of snapping surfaces 518 engages each snap surface in the plurality of snapping surfaces 518 at substantially the same time.

The plurality of snaps 540 are shown as cantilever snap structures having a “U”-shape. Each cantilever snap structure is configured to put equal pressure on the O-rings that are disposed throughout the actuator 500. Six cantilever snap structures are shown in the plurality of snaps 540 and are disposed at various locations along the internal middle surface 536 so that the plurality of snaps 540 do not interfere with the internal components of the actuator 500. In other embodiments, the number and/or placement of the plurality of snaps 540 may be varied to generate a wide variety of engagement elements.

As shown in FIG. 6C, each snap protrusion 608 extends from the internal middle surface 536 by a length 610, which is greater than the length 606. Each snap protrusion 608 includes a flexible member 616 at the base of the snap protrusion, or at the location where the snap protrusion 608 engages the internal middle surface 536. The flexible member 616 facilitates the inward and outward radially flexing of each snap protrusion 608 as the snap protrusions 608 engage a complementary snap surface on the housing 502. A plurality of step surfaces 614 are disposed along the internal middle surface 536 and may be configured to securely engage the first housing end 522 of the housing 502 to provide IP54 ingress protection.

FIG. 7 is a cross-sectional side view of the actuator 500 of FIG. 5 with internal components 720 to form an assembled actuator 500, according to an exemplary embodiment. In order to have IP54 ingress protection in all directions, an O-ring 722 is disposed between the socket 520 and an exterior surface 706. The socket 520 may receive the overmolded cable. Specifically, the socket 520 may be sized to receive a female connector 702 of the overmolded cable. The socket 520 may include an interior passage 704 and an exterior surface 706. The female connector 702 of the overmolded cable may be guided into the interior passage 704 of the socket 520. The socket 520 may include a male connector 708. The male connector 708 may be electrically connected to the female connector 702. The male connector 708 may include a number of prongs which are inserted into the female connector 702. The male connector 708 may be electrically coupled to internal circuitry within the housing 502. Accordingly, the male connector 708 may provide signals received from the female connector 702 to the internal circuitry for powering the actuator 500, controlling various motors or other outputs from the actuator 500, etc. Additionally, the actuator 500 may provide signals to an external source (e.g., one or more components in the HVAC, airside, waterside, or BMS system 100, 200, 300, 400) via the male/female connectors 708, 702.

In order to have IP54 ingress protection in all directions, an O-ring 724 is disposed between the nut 726 of the housing 502 to sealingly engage the bottom portion of the actuator 500. The nut 726 is threadedly engaged with the spindle 730. The nut 726 includes an internal nut surface, the external nut surface 732, and an interface end. The external nut surface 732 slidingly engages an adaptor 734 and the O-ring 724 is disposed between the external nut surface 732 and the adaptor 734. The various O-rings 552, 722, 724 are located around the actuator 500 to ensure that the various components, such as, a gear train 750, a plate assembly 752, and circuit board 754 disposed within the actuator 500.

Turning to FIGS. 8A-8D, various portions 810, 830, 850, 870 of the actuator 500 are shown. FIG. 8A shows a portion 810 of the upper left portion of the actuator 500. The portion 810 highlights the engagement of the middle cover 508, the top cover 506, and the housing 502, the engagement of the plurality of snapping surfaces 518 and the plurality of snaps 540, and the O-ring 552. FIG. 8B shows a portion 830 of the upper middle portion of the actuator 500. The portion 830 highlights the engagement of the middle cover 508, the top cover 506, and the housing 502, the engagement of the plurality of snapping surfaces 518 and the plurality of snaps 540, and the O-ring 545. FIG. 8C shows a portion 850 of the upper right portion of the actuator 500. The portion 850 highlights the engagement of the middle cover 508, the top cover 506, and the housing 502, the engagement of the female connector 702 of the overmolded cable and the male connector 708 disposed in the socket 520, and the O-ring 722. FIG. 8D shows a portion 870 of the lower left portion of the actuator 500. The portion 870 highlights the engagement of the adaptor 734 and the nut 726 that includes the O-ring 724.

HVAC Actuator with Ease of Assembly

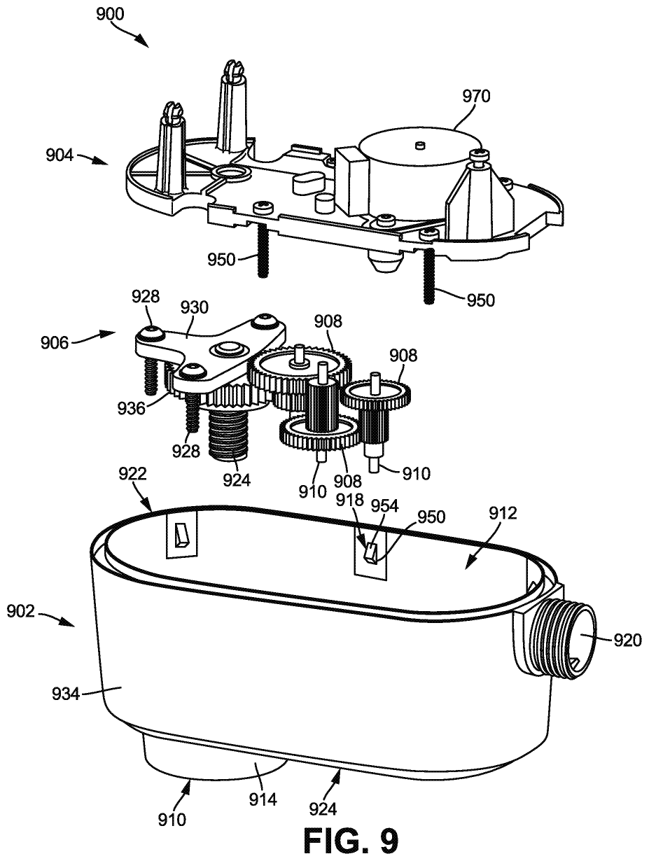

Referring now to FIG. 9, an unassembled actuator 900 is shown, according to an exemplary embodiment. Generally, the actuator 900 includes feature and elements that provide for ease of assembly and mounting of the actuator components. In some implementations, the actuator 900 may be used in HVAC system 100, waterside system 200, airside system 300, or BMS system 400, as described with reference to FIGS. 1-4. For example, actuator 900 may be a damper actuator, a valve actuator, a fan actuator, a pump actuator, or any other type of actuator that may be used in an HVAC system or BMS. In various embodiments, actuator 900 may be a linear actuator (e.g., a linear proportional actuator), a non-linear actuator, a spring return actuator, or a non-spring return actuator.

Actuator 900 is shown to include a housing 902. The housing 902 may contain the mechanical and processing components of actuator 900 when assembled. In some embodiments, housing 902 contains a brushless direct current (BLDC) motor and a processing circuit configured to provide a pulse width modulated (PWM) DC output to control the speed of the BLDC motor. In other embodiments, the housing 902 may contain other types of motors that are controllable (e.g., by the various processing components of the actuator 900 and/or the HVAC or BMS system 100, 400).

Actuator 900 may generally provide a mechanical output to various devices in the HVAC, waterside, airside, or BMS systems 100, 200, 300, 400. The actuator 900 may be a rotary actuator, a linear actuator, etc. Accordingly, the actuator 900 may provide different types of force outputs depending on configuration.

As shown in FIG. 9, the actuator 900 includes a housing 902, an assembly plate 904, and a gear train 906. The housing 902 is similar to the housing 502 of FIG. 5. A difference between the housing 502 and the housing 902 is the housing 902 includes a housing base 1002 that is configured to receive the gear train 906 and assembly plate 904 for both linear and rotary valves. The housing base 1002 may include one or more housing bosses that are configured to engage the gear train 906 and other features that are configured to facilitate proper engagement of the gear train components with each other and with the housing 902. The assembly plate 904 is configured to be compatible to store electronic components within the actuator 900 and the assembly plate 904 can accommodate both rotary and linear valves and a wide variety of gear train designs. The assembly plate 904 is configured to facilitate proper installation and storage of electronic components of the actuator 900 and to accommodate that actuator 900 engagement with both linear and rotary valves.

The housing 902 includes a first housing end 922, a second housing end 924, an outer surface 934 disposed between the first housing end 922 and second housing end 924, and an interior housing surface 912 between the first housing end 922 and second housing end 924. The outer surface 934 and the interior housing surface 912 define the body (e.g., outside and inside, respectively) of the housing 902. The housing 902 includes a cylindrical channel wall 914 extending from the second housing end 924. An output channel 916 is formed within the channel wall 914, which is in communication with the interior housing surface 912. An O-ring groove 990 is disposed around a portion of the first housing end 922 and configured to receive an O-ring. As will be appreciated, the O-ring may be configured to provide IP94 ingress protection.

The channel wall 914 extends from the second housing end 924 and may be substantially cylindrical with openings at an exterior end and an interior end. The channel wall 914 defines an output channel 916 that allows access to the interior housing surface 912 from outside the actuator 900. The channel wall 914 has an interior surface that runs along the output channel 916. The channel wall 914 may have a uniform thickness or may taper towards the exterior end. The channel wall 914 is configured to receive and facilitate engagement of the actuator 900 with linear and rotary valves.

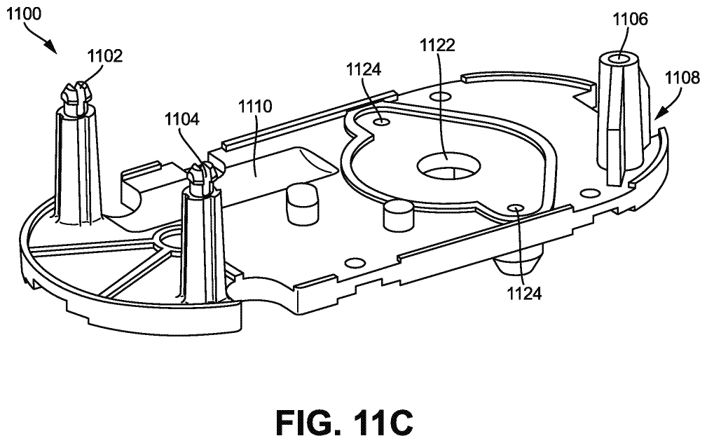

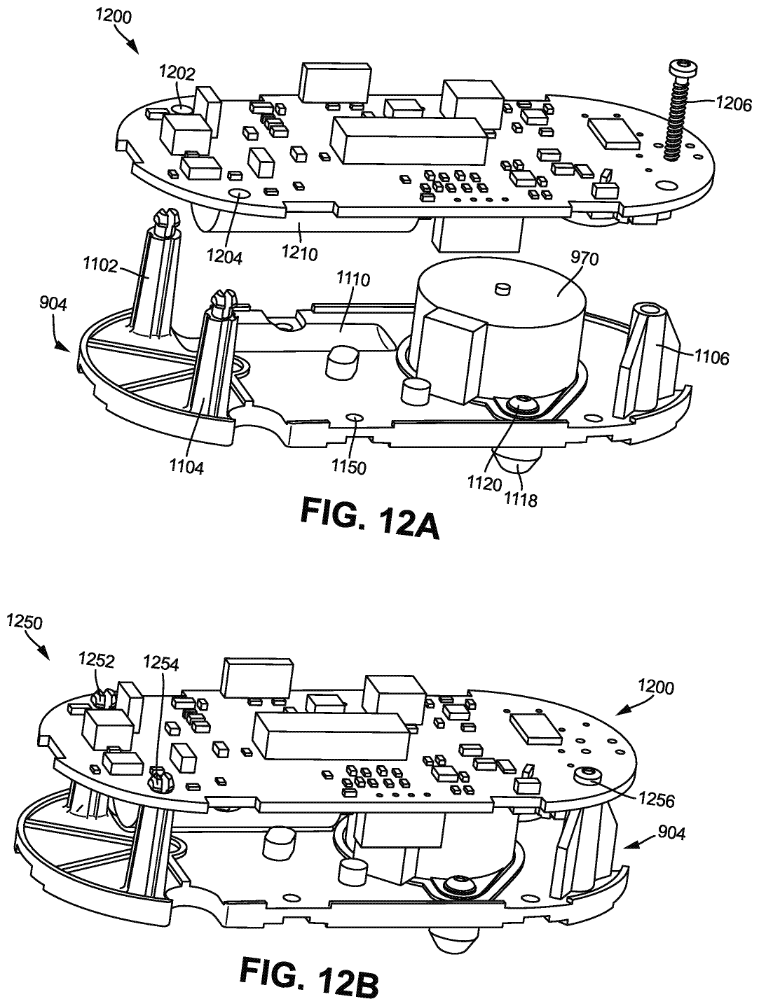

The interior housing surface 912 may receive or support any combination of control systems or circuit boards, electrical, hydraulic, pneumatic, or other power systems, gear trains or other mechanical components, or any other elements useful for the operation of actuator. For example, as shown in FIG. 9 and FIG. 12B, the interior housing surface 912 is configured to receive a four-stage gear train 906, an assembly plate 904 including a motor 970, and a circuit board 1200. In some embodiments, the interior volume contains a brushless direct current (BLDC) motor and a processing circuit configured to provide a pulse width modulated (PWM) DC output to control the speed of the BLDC motor. In other embodiments, the housing 902 may contain other types of motors that are controllable (e.g., by the various processing components of the actuator 900 and/or implemented systems).

The actuator 900 may receive power and/or control inputs from a remote source through the socket 920. In some embodiments, actuator 900 may include a cable for receiving power or control inputs. For example, the socket 920 is shown as threaded to engage a coupling device and cable. The actuator 900 may receive inputs and/or power from an overmolded cable. The overmolded cable may be attached to the housing 902 of the actuator 900 via a coupling device. For example, the coupling devices may be screwed into the socket 920 with a neck of the coupling devices pressed up against a stopper to secure the overmolded cable to the housing 902.

A plurality of snapping surfaces 918 are disposed along the interior housing surface 912. The plurality of snapping surfaces 918 are shown in FIG. 9 as having a trapezoidal shape with a slanted rectangular face on the top portion 954 and a rectangular prism bottom portion 956, formed as a single unit. A plurality of cantilever snap indentations 932 (e.g., receiving surface) may each be disposed around each snapping surface in the plurality of snapping surfaces 918. In some embodiments, each snap indentation in the plurality of cantilever snap indentations 932 is configured to receive a complementary snap in a plurality of snaps on a middle cover and facilitate the engagement of a middle cover and the housing 902, for example, the plurality of snaps 540 of the middle cover 508 shown in FIGS. 5-8C.

The gear train 906 is configured to amplify or otherwise modify the torque exerted by motor 970 onto a drive member or similar feature by providing a mechanical advantage via multiple stages of the gear train 906. In some embodiments, the gear train 906 is a four-stage gear train with four compound spur gear that is configured to interface with a linear valve. The four-stage gear train 906 can be configured to amplify or otherwise modify the torque exerted by motor 970 on a drive device or similar feature by providing a mechanical advantage via multiple stages of meshing gears. In other embodiments, the gear train 906 is a six-stage gear train 906 with six compound spur gears that is configured to interface with a rotary valve or another member that will interface with the rotary valve. The six-stage gear train 906 can be configured to amplify or otherwise modify the torque exerted by motor 970 on a drive device or similar feature by providing a mechanical advantage via multiple stages of meshing gears. The gear train 906 is configured to amplify or otherwise modify the torque exerted by the motor 970 through the spindle 926 to an output device. In some embodiments, the spindle 926 includes a nut portion threadedly engaged to the spindle 926 to interface with a linear or rotary valve.

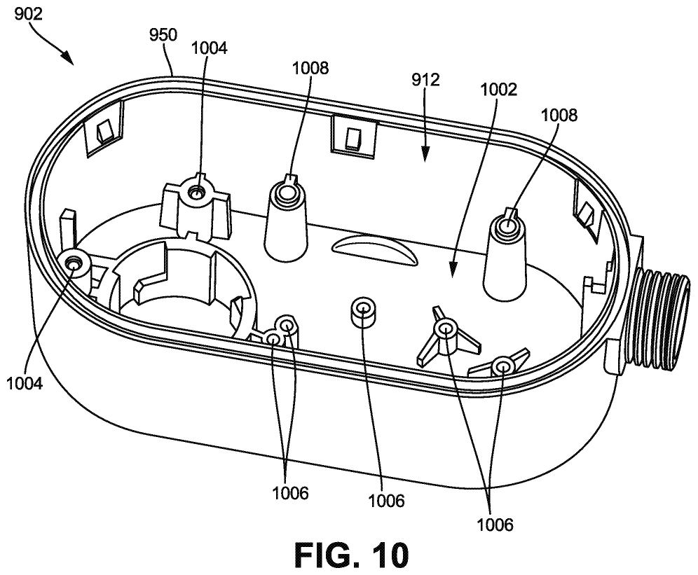

Each gear 908 in the gear train 906 rotates around a central axle 9100 with the last gear 936 in the gear train 906 rotating about a spindle 926. As shown in FIG. 10, the housing base 1002 may include a plurality of gear shaft locators 1006 to receive the central axle 910 of each gear 908. The plurality of gear shaft locators 1006 are configured to provide ease and accuracy of installation of the central axles 910 of the gear train 906 within the housing 902. Specifically, the axially protruding structures of the plurality of gear shaft locators 1006 are configured to come into contact with the central axles 910 of the gear 908 is at an early stage of installation to signal to the user (e.g., installer) if the gear train 906 is properly aligned within the housing 902 (e.g., no contact means improper installation). As will be appreciated, the housing base 1002 may include more gear shaft locators 1006 at different locations along the surface of the housing base 1002 to accommodate different gear train configurations. In some embodiments, the housing base includes a plurality of gear shaft locators that are configured for a linear gear train design and a plurality of gear shaft locators that are configured for a rotary gear train design in the same housing base 1002. Each gear shaft locator in the plurality of gear shaft locators 1006 is configured to sustain the load transferred from the gear shaft. Beneficially, the plurality of gear shaft locators 1006 impedes misalignment of the gear train 906 within the housing 902 by providing one or more “poke-yoke” features.

The gear train 906 includes a bracket 930 and a plurality of screws 928 configured to facilitate installation of the gear train 906 within the interior housing surface 912 of the housing 902. As shown in FIG. 10, the housing base 1002 may include a plurality of bracket locators 1004 to receive the plurality of screws 928. The plurality of bracket locators 1004 are configured to provide ease and accuracy of installation of the bracket 930 and gear train 906 within the housing 902. Specifically, the axially protruding structures of the plurality of bracket locators 1004 are configured to come into contact with the plurality of screws 928 (e.g., engagement member) as the bracket 930 and gear train 906 is at an early stage of installation to signal to the user (e.g., installer) if the gear train 906 is properly aligned within the housing 902 (e.g., no contact means improper installation). Beneficially, the plurality of bracket locators 1004 impedes misalignment of the gear train 906 within the housing 902 by providing one or more “poke-yoke” features.

As shown in FIG. 10, the housing base 1002 also includes a plurality of assembly plate locators 1008 configured to receive a plurality of screws 950 of the assembly plate 904 during installation of the assembly plate 904 within the interior housing surface 912 of the housing 902. The plurality of assembly plate locators 1008 are configured to provide ease and accuracy of installation of the assembly plate 904 within the housing 902. Specifically, the axially protruding structures of the assembly plate locators 1008 are configured to come into contact with the plurality of screws 950 as the assembly plate 904 is at an early stage of installation to signal to the user (e.g., installer) if the assembly plate 904 is properly aligned within the housing 902 (e.g., no contact means improper installation). Beneficially, the plurality of assembly plate locators 1008 impedes misalignment of the assembly plate 904 within the housing 902 by providing one or more “poke-yoke” features.

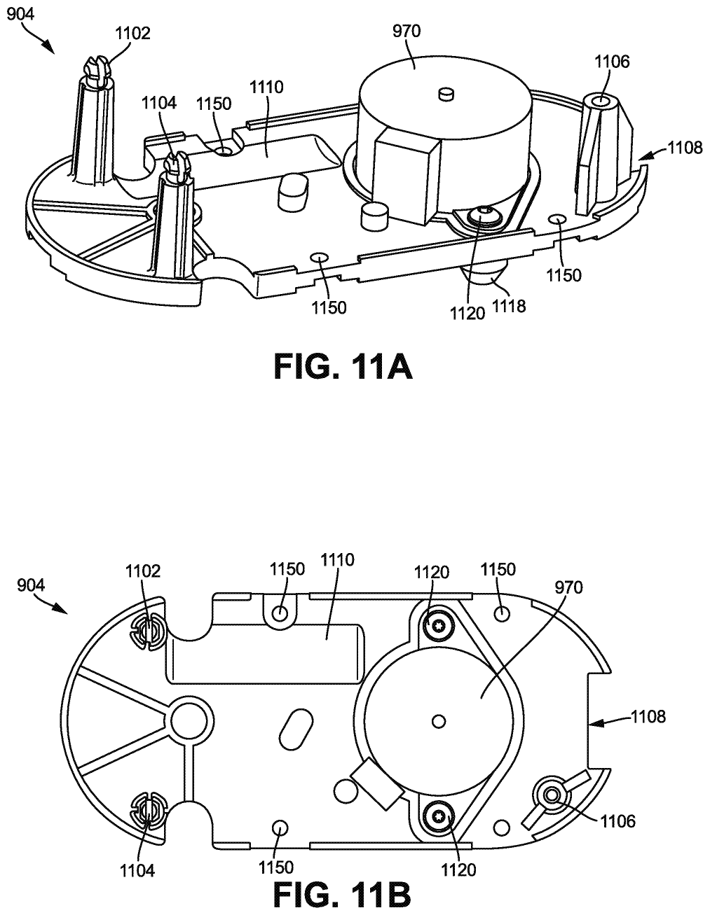

Turning to FIGS. 11A-11C, the assembly plate 904 of the actuator 900 is shown. The assembly plate 904 is configured to allow for the mounting of an electrical storage component (e.g., capacitor) and circuit board with a motor 970. The assembly plate 904 provides a “poke-yoke” installation process of the assembly plate 904 into the housing 902 and of the motor 970 into the assembly plate 904. The assembly plate 904 includes a first protruding snap member 1102, a second protruding snap member 1104, a protruding nut 1106, an axial support member 1118, an indented electrical storage surface 1110. A plate opening 1108 is formed on an end of the assembly plate 904 and is configured to allow for power and/or control inputs from a remote source to travel through the assembly plate 904 to the socket 920. A plurality of holes 1150 are formed around the central outside portion of the assembly plate 904 and are configured to receive the plurality of screws 950 to facilitate the installation of the assembly plate 904 within the housing base 1002. As shown in FIG. 11C, the motor-less assembly plate 1100 includes a pole-yoke snap feature 1122 to receive the motor 970 and a plurality of nut members 1124 to receive one or more screws to secure the motor 970 to the assembly plate 1100.

The first protruding snap member 1102 and second protruding snap member 1104 are configured to engage a snap-opening in a circuit board, printed control board, or similar electronic control circuit. As will be appreciated, through the use of the snap-features (e.g., first protruding snap member 1102 and second protruding snap member 1104), the assembly plate 904 reduces the number of screws needed for engagement of a circuit board with the assembly plate 904, reduces the assembly time of the circuit board with the assembly plate 904, and reduces the likelihood of errors.

Turning to FIG. 12A, an unassembled circuit board 1200 and assembly plate 904 are shown, according to an example embodiment. The circuit board 1200 includes a first engagement opening 1202, a second engagement opening 1204, a screw 1206, and a capacitor 1210. As shown in FIG. 12B, the first engagement opening 1202 receives the first protruding snap member 1102 of the assembly plate 904 at a first engagement location 1252; the second engagement opening 1204 receives the second protruding snap member 1104 of the assembly plate 904 at a second engagement location 1254; the screw 1206 is inserted into and engages with the protruding nut 1106 of the assembly plate 904 at a third engagement location 1256. The indented electrical storage surface 1110 of the assembly plate 904 receives the capacitor 1210. The engagement of the assembly plate 904 and the circuit board 1200 forms an assembled circuit plate 1250.

### CONFIGURATION OF EXEMPLARY EMBODIMENTS

The construction and arrangement of the systems and methods as shown in the various exemplary embodiments are illustrative only. Although only a few embodiments have been described in detail in this disclosure, many modifications are possible (e.g., variations in sizes, dimensions, structures, shapes and proportions of the various elements, values of parameters, mounting arrangements, use of materials, colors, orientations, etc.). For example, the position of elements may be reversed or otherwise varied and the nature or number of discrete elements or positions may be altered or varied. Accordingly, all such modifications are intended to be included within the scope of the present disclosure. The order or sequence of any process or method steps may be varied or re-sequenced according to alternative embodiments. Other substitutions, modifications, changes, and omissions may be made in the design, operating conditions and arrangement of the exemplary embodiments without departing from the scope of the present disclosure.

The present disclosure contemplates methods, systems and program products on any machine-readable media for accomplishing various operations. The embodiments of the present disclosure may be implemented using existing computer processors or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

Although the figures show a specific order of method steps, the order of the steps may differ from what is depicted. Also, two or more steps may be performed concurrently or with partial concurrence. Such variation will depend on the software and hardware systems chosen and on designer choice. All such variations are within the scope of the disclosure. Likewise, software implementations could be accomplished with standard programming techniques with rule based logic and other logic to accomplish the various connection steps, processing steps, comparison steps, and decision steps.

What is claimed is:

1. An actuator, comprising:
a cover, comprising:
a first cover end,
a second cover end disposed axially away from the first cover end, the second cover end in contact with a lower body;
a cover surface disposed between the first cover end and the second cover end;
a protrusion radially disposed along an external surface of the cover surface; and
a plurality of snap elements that extend axially away from the first cover end; and
the lower body, comprising:
a first body end, the first body end configured to receive the second cover end;
a second body end disposed axially away from the first body end;
a body surface extending axially between the first cover end and the second cover end; and
a plurality of snapping surfaces disposed along an internal surface of the body surface, the plurality of snapping surfaces configured to engage the plurality of snap elements.

2. The actuator of claim 1, further comprising a top cover, the top cover comprising:
a first top end,
a second top end disposed axially away from the first top end, the second top end in contact with the first cover end;
a top surface disposed between the first top end and the second top end;
a groove radially disposed along an internal surface of the top surface, wherein the protrusion radially disposed along the external surface of the cover surface is configured to engage the groove radially disposed along the internal surface of the top surface.

3. The actuator of claim 2, wherein the first body end further comprises a body channel, the body channel configured to receive a seal member and sealingly engage with the second cover end.

4. The actuator of claim 2, wherein the first cover end further comprises a cover opening and a cover channel, the cover channel configured to receive a seal member and sealingly engage with the internal surface of the first top end.

5. The actuator of claim 1, wherein each snap element in the plurality of snap elements comprises:
a first axial sidewall extending axially away from the first cover end toward the second cover end, the first axial sidewall configured to flex radially;
a second axial sidewall extending axially away from the first cover end toward the second cover end, the second axial sidewall substantially parallel to the first axial sidewall, the second axial sidewall configured to flex radially; and
an engagement surface disposed between the first axial sidewall and the second axial sidewall, the engagement surface configured to contact the plurality of snapping surfaces and cause the first axial sidewall and the second axial sidewall to flex radially.

6. The actuator of claim 5, wherein each snap surface in the plurality of snapping surfaces comprise a slanted axially extending rectangular surface, the axially extending rectangular surface configured to engage the engagement surface on each snap element in the plurality of snap elements, wherein the engagement causes each snap element in the plurality of snap elements to flex radially inward.

7. The actuator of claim 1, wherein the plurality of snapping surfaces are adjacent to the first body end.

8. The actuator of claim 1, wherein the lower body further comprises a body base adjacent the second body end, the body base comprising a plurality of gear shaft locators, each gear shaft locator in the plurality of gear shaft locators configured to receive an axle of a gear in a gear train.

9. The actuator of claim 1, wherein the lower body further comprises a body base adjacent the second body end, the body base comprising a plurality of bracket locators, each bracket locator in the plurality of bracket locators configured to receive an engagement member of a bracket, the bracket configured to secure a gear train within the lower body.

10. The actuator of claim 1, wherein the lower body further comprises a body base adjacent the second body end, the body base comprising a plurality of assembly plate locators, each assembly plate locator in the plurality of assembly plate locators configured to receive an engagement member of an assembly plate.

11. The actuator of claim 1, further comprising an assembly plate contained within the lower body, the assembly plate comprising a first protruding snap member, a second protruding snap member, and a motor.

12. The actuator of claim 11, further comprising a circuit board, the circuit board comprising a first opening and a second opening, the first opening configured to receive the first protruding snap member, and the second opening configured to receive the second protruding snap member.

13. The actuator of claim 11, further comprising a gear train contained within the lower body and coupled to a movable component for driving the movable component between multiple positions, the gear train comprising:
a plurality of shafts; and
at least one compound gear freely and rotatably mounted on each shaft in the plurality of shafts, each compound gear comprising a main gear, a pinion gear, and a gear hub, the main gear co-axial with the pinion gear and the gear hub, the gear hub configured to reduce fouling of bosses to the at least one compound gear,
each compound gear on each shaft intermeshed with a compound gear on another shaft in the plurality of shafts, the intermeshing configured to transfer torque, wherein at least one compound gear is operably connected to the motor.

14. A method of assembling an actuator, the method comprising:
placing a cover over a lower body, the cover, comprising a first cover end, a second cover end disposed axially away from the first cover end, the second cover end in contact with a lower body, a cover surface disposed between the first cover end and the second cover end, a protrusion radially disposed along an external surface of the cover surface; and a plurality of snap elements that extend axially away from the first cover end, the lower body, comprising a first body end, the first body end configured to receive the second cover end, a second body end disposed axially away from the first body end, a body surface extending axially between the first cover end and the second cover end, and a plurality of snapping surfaces disposed along an internal surface of the body surface;
engaging the lower body with the cover, the engagement comprising the plurality of snap elements contacting the plurality of snapping surfaces and engaging to secure the cover onto the lower body.

15. The method of claim 14, wherein before engaging the lower body with the cover, further comprising:
inserting gear train within lower body, the gear train comprising a plurality of shafts and at least one compound gear freely and rotatably mounted on each shaft in the plurality of shafts, each compound gear comprising a main gear, a pinion gear, and a gear hub, the main gear co-axial with the pinion gear and the gear hub, the gear hub configured to reduce fouling of bosses to the at least one compound gear, each compound gear on each shaft intermeshed with a compound gear on another shaft in the plurality of shafts, the intermeshing configured to transfer torque, wherein each shaft is aligned with a complementary gear shaft locator dispose within the lower body.

16. The method of claim 15, wherein before engaging the lower body with the cover, further comprising:
securing a bracket to the gear train, the bracket configured to secure the gear train to the lower body, the bracket comprising at least one screw configured to engage at least one nut member in the lower body.

17. The method of claim 15, wherein before engaging the lower body with the cover, further comprising:
inserting an assembly plate within the lower body above the gear train, the assembly plate comprising a first protruding snap member, a second protruding snap member, and a motor, the motor configured to drive the gear train.

18. The method of claim 17, wherein before engaging the lower body with the cover, further comprising:
inserting a circuit board into the lower body; the circuit board comprising a first opening and a second opening;
securing the circuit board to the assembly plate, the first opening receiving the first protruding snap member and the second opening receiving the second protruding snap member.

19. The method of claim 14, further comprising securing a top cover to the cover, the top cover comprising a first top end, a second top end disposed axially away from the first top end, the second top end in contact with the first cover end, a top surface disposed between the first top end and the second top end, and a groove radially disposed along an internal surface of the top surface, wherein the protrusion radially disposed along the external surface of the cover surface engages the groove radially disposed along the internal surface of the top surface top secure the top cover to the cover.

20. The method of claim 14, wherein each snap element in the plurality of snap elements comprises a first axial sidewall extending axially away from the first cover end toward the second cover end, the first axial sidewall configured to flex radially; a second axial sidewall extending axially away from the first cover end toward the second cover end, the second axial sidewall substantially parallel to the first axial sidewall, the second axial sidewall configured to flex radially; and an engagement surface disposed between the first axial sidewall and the second axial sidewall, the engagement surface configured to contact the plurality of snapping surfaces and cause the first axial sidewall and the second axial sidewall to flex radially and wherein each snap surface in the plurality of snapping surfaces comprises a slanted axially extending rectangular surface, the axially extending rectangular surface configured to engage the engagement surface on each snap element in the plurality of snap elements, wherein the engagement causes each snap element in the plurality of snap elements to flex radially inward.
